(19) United States
(12) Patent Application Publication
(10) Pub. No.: US 2009/0076928 A1
(43) Pub. Date: Mar. 19, 2009

(54) System and method for automating RFP process and matching RFP requests to relevant vendors

(75) Inventors: Oskar H. Hjertonsson, Santiago (CL); Daniel Undurraga, Santiago (CL); Johan Ehn, Stockholm (SE); Ricardo Zilleruelo, Santiago (CL)

Correspondence Address: BAKER & MCKENZIE LLP;PATENT DEPARTMENT, 2001 ROSS AVENUE, SUITE 2300, DALLAS, TX, 75201, US

(73) Assignee: NEEDISH, INC., Wilmington, DE (US)

(21) Appl. No.: 12/200,650

(22) Filed: Aug. 28, 2008

Related U.S. Application Data
(60) Provisional application No. 60/968,481, filed on Aug. 28, 2007.
(60) Provisional application No. 61/036,548, filed on Mar. 14, 2008.

(51) Int. Cl. G06Q 30/00; G06N 7/00; G06Q 99/00; G06F 15/18

(52) U.S. Cl. 705/26; 706/52; 706/14; 705/1

(57) ABSTRACT

Disclosed is an open online system that allows users to use an automated Request for Proposal (RFP) process powered by a modern communicational web-platform. The system adapts to user feedback, and provides the automated communicational platform to administrate the RFP process; letting users post so-called “Needs,” “NeedCatchers,” “NeedTrackers,” “Helps,” and “Pro-helps.” Needs are buying signals similar to RFPs, providing a request for a service, good, advice, or other information. NeedCatchers and NeedTrackers are implemented by users, and contain tables of words and data defined by a user, wherein the words and data relate to services, products, or information in which the user is interested in providing to other users. The NeedCatchers and NeedTrackers act as a way to receive posted Needs that are relevant to the words and data defined in the user's NeedCatcher or NeedTracker. “Help” and “Pro-help” are ways of providing information to a user posting a Need.

### CROSS-REFERENCE TO RELATED APPLICATIONS

This disclosure claims priority to U.S. Provisional Patent Application Nos. 60/968,481 and 61/036,548, both entitled “System and Method for Automating RFP Process and Matching RFP Requests to Relevant Vendors,” filed Aug. 28, 2007 and Mar. 14, 2008, respectively. Both of these provisional patent applications are hereby incorporated by reference herein.

### TECHNICAL FIELD

The disclosed embodiments relate generally to automated matching systems and, more specifically, to a system and method for automating a request for proposal (RFP) process with matching RFP requests to relevant vendors.

### BACKGROUND

There are well-known auction sites, such as eBay or craigslist (trademarks of their respective holders), that allow Internet buyers to find items for purchase through the buyers' searching through items for sale. This approach places the burden on buyers to sort through and identify needed or desired items. Further, although on such sites a buyer can do searches for items of interest, there are no communities established to “network” for interests or to collaborate for buying and/or selling of items or services.

### SUMMARY

Disclosed is an open online system that allows users to use an automated Request for Proposal (RFP) process powered by a modern communicational web-platform. The disclosed system adapts to user feedback, and provides the automated communicational platform to administrate the RFP process, letting users post so-called “Needs,” “NeedCatchers,” “NeedTrackers,” “Helps,” and “Pro-helps.” While the present document uses these specific, current commercial terms to describe the processes of the presently described embodiments, the meaning of these terms should be generically and specifically interpreted in the present specification according to the breadth of the terms implied in the present specification. No specific commercial implementation is intended to be incorporated by reference herein, and the terms of any patent that issues from the present document shall be construed based on the description provided herein.

The Need is a buying signal similar to a RFP, generally providing a request for a service, good, advice, or other information. NeedCatchers and NeedTrackers contain collections of words and data defined by a user, wherein the words and data generally relate to services, products, or general information that a providing user is interested in providing to other receiving or “Needy” users—whether the user intends to provide that information for a fee or for free. The NeedCatchers and NeedTrackers are usually implemented by the receiving user as a way to receive posted Needs that are relevant to the words and data defined in the user's NeedCatcher or NeedTracker. “Help” and “Pro-help” are ways for a providing user to provide information to a receiving user who has posted a Need. A Help is typically a response to a user's Need, and may be considered an offering of service or goods (usually at a price), but can also be—even without commercial interest—information, advice, hints, help, referrals, and the like. Pro-help is generally the same as Help, but is usually submitted by a commercial or power user with a premium profile, where a premium profile is a profile that would typically be provided to a commercial provider for a fee or in recognition of other benefits provided by the commercial or power user.

Using the disclosed system, a user creates a profile, and chooses to use the profile to represent the user as an individual person (as a “social user”) or to relate its profile to a company and act in the name of that company (as a “commercial user”). As described, any user can act as a “Buyer” and a “Vendor” using a single account. In this disclosure, a user's intent of buying or selling will be inherently understood by context, and specifically by the mentioning of Needs (acts of buying or receiving information), NeedCatchers and NeedTrackers (profile for selling or providing information), and Helps or Pro-helps (acts of selling or providing information). It is understood that a social user and a commercial user may each act as both a Buyer and a Vendor, and that all acts of selling and providing information and of buying and receiving information should be broadly construed according to the context described herein for those activities.

The daily usage of the disclosed system is centered on the Needs and the Helps or Pro-helps that users post. The general approach is illustrated by the following example:
1) User A quickly and easily posts a Need.
2) User B views that posted Need.
3) User B submits Help (or Pro-help).
4) User A views and evaluates the Help.
5) For a commercial transaction, a deal is closed, and payment is sent through the disclosed system, or through a third party.

### BRIEF DESCRIPTION OF THE DRAWINGS

Embodiments are illustrated by way of example in the accompanying figures, in which like reference numbers indicate similar parts, and in which:

FIGS. 1A-B illustrate the invention's proposed philosophical change for the flow of online information;

FIG. 2 is an exemplary system diagram illustrating the various elements of the disclosed system;

FIG. 3 illustrates an exemplary social user profile;

FIG. 4 illustrates an exemplary Need format/template;

FIG. 5 illustrates an exemplary request for an invitation to invite users to join the disclosed system;

FIG. 6 illustrates an exemplary Help response format;

FIG. 7 illustrates an exemplary Pro-Help response format;

FIG. 8 illustrates an exemplary user profile detailing the user's Friends' Needs;

FIG. 9 illustrates an exemplary commercial user's basic company profile;

FIG. 10 illustrates an exemplary commercial user's premium company profile;

FIG. 11 illustrates an exemplary NeedTracker as entered by the user posting the NeedTracker;

FIG. 12 illustrates an exemplary user profile with the listed Needs relevant to the user's NeedTracker;

FIG. 13 illustrates an exemplary NeedCatcher as entered by the user posting the NeedCatcher;

FIG. 14 illustrates an exemplary flowchart of the disclosed system's core function; and

FIGS. 15A and 15B illustrate timelines of exemplary operations as performed by three users and the disclosed system.

### DETAILED DESCRIPTION

### Overview

In disclosed embodiments Needs and Helps may include public content which may be viewed or accessed by anyone using the disclosed system. Thus, a user publicly promoting a product or service not only promotes to one user, but to all users that view that Need and its corresponding Helps. This wide communication approach makes communication through the disclosed system more efficient when trying to reach a broad audience of users. In further disclosed embodiments, Needs and Pro-helps may include private content, wherein the private content is only visible to selected recipients. This allows for private communication between users.

A user is typically involved with a network of other users called “Friends.” Friends are a group of users that grant viewing and information-sharing privileges to each other. Friends are invited to participate in a user's network so they can share each others' Needs and provide Helps to each other. Friends typically provide Helps to each other, with information, advice, real-life help, and referrals to third parties to meet the other Friends' Needs.

Users can endorse companies in the disclosed system by becoming their “Fans.” A Fan is a user that subscribes to a company's profile to promote or endorse that company. In other words, a user being a Fan of a company is similar to a user being a Friend of a second user, wherein the second user is the company. Having Fans gives service providers support, and provides all users the ability to select products or services from companies that Friends—and other users—endorse. Users can also search a directory of companies in the disclosed system, and—if they want—sort results by “Fans that are friends” or “Fans that are friends of friends.”

Companies may create a profile in the system, giving them the ability to “Help out” as a means of making offers of their services or products, or offering their expertise for Needs within their realm of knowledge. In this way, traffic is driven to a company's profile within the system, a space in which content and design may be customized and updated regularly, giving the system a company directory where every company profile can be current and different from others. The company profiles are easily customized by the company (or user providing the company profile) and may be updated regularly. The company profile may contain data and objects (e.g., pictures, attachments, links, etc. . . . ) to provide an interactive webpage much like a blog. Companies typically include their profile in commercial user accounts, rather than social user accounts, although commercial user accounts do not necessarily contain company profiles.

The disclosed system is operable to interface with third-party hosts, providing access to the system through another service provider. Access to the third party is available through an Application Programming Interface (API). The third-party service provider may be any other service through which the system operates, including, for example, websites, browsers, or desktop-applications. The number of third-party service providers that may be used is virtually unlimited, and include other types of third-party services beyond what is described in the present disclosure.

Aspects of the disclosed system may be customized by the users. For example, users may customize many features of their accounts, and may offer feedback to the system or its administrators. The system or its administrators may react to this feedback by updating/changing features of the overall system, or even adjusting features only for an individual user. Because of the flexibility of the system and its ability to adjust to feedback while providing an automated Request for Proposal matching service, the disclosed system is considered both automated and adaptable.

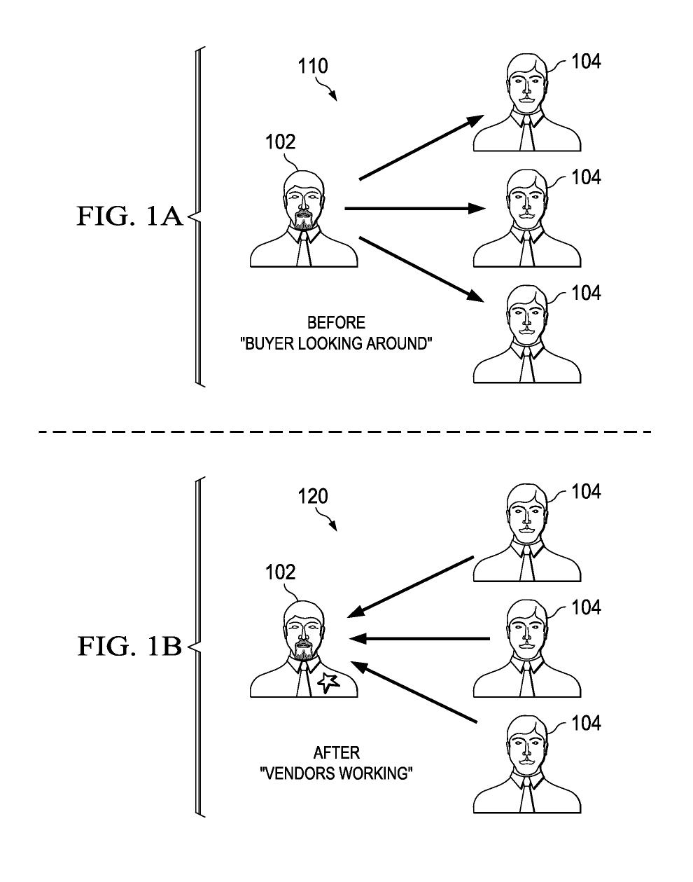

As illustrated in FIGS. 1A and 1B, the disclosed system proposes a powerful philosophical change for the flow of online information. The “Before” system 110 requires a Buyer 102 to actively search for Vendors 104 to meet the Buyer's needs. The currently described approach (“After” system) 120 provides an automated platform for Vendors 104 to bring their services to the Buyer 102. The disclosed embodiments provide both a proactive and global approach, in which users produce and present existing information as Needs in the system, and a reactive and local approach, in which local users can respond to the posted Needs with Helps.

For users, the disclosed system 120 is a new way of being supported in the process of pre-buying, which is presently defined as the process of reaching a decision on what product or service to purchase and from whom it should be purchased. The disclosed system 120 also provides for the possibility for Buyers 102 to pay Vendors 104 through the system.

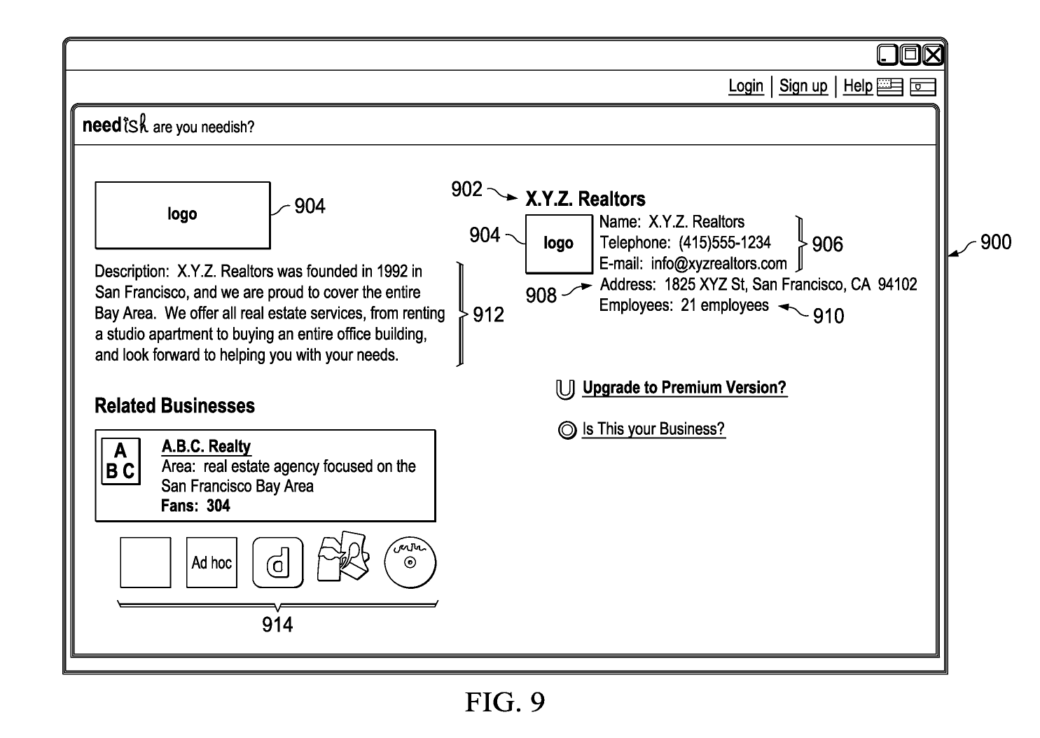

For users with company profiles, as further described below (see, e.g., FIG. 9 and accompanying text), the disclosed system 120 provides a new way of subscribing to leads or prospects and a tool for quickly and easily replying to or providing help for Needs published by those leads or prospects. This service 120 can be used in any combination of buyer-to-vendor, buyer-to-buyer, vendor-to-vendor, and vendor-to-buyer.

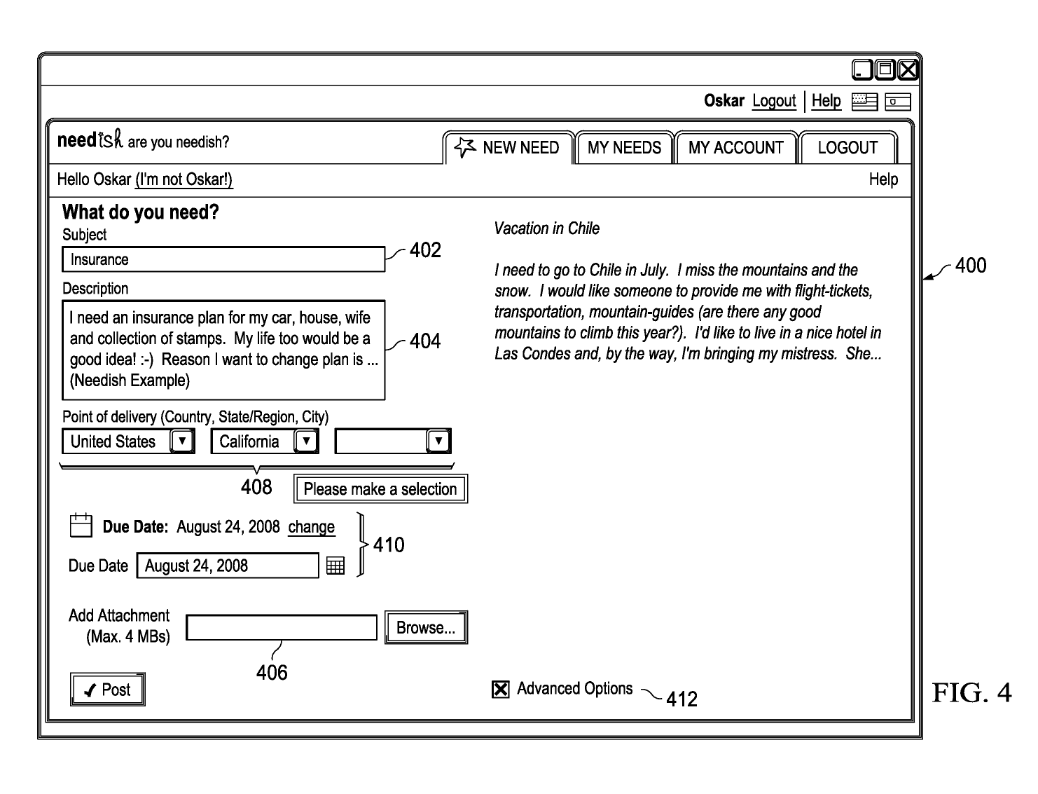

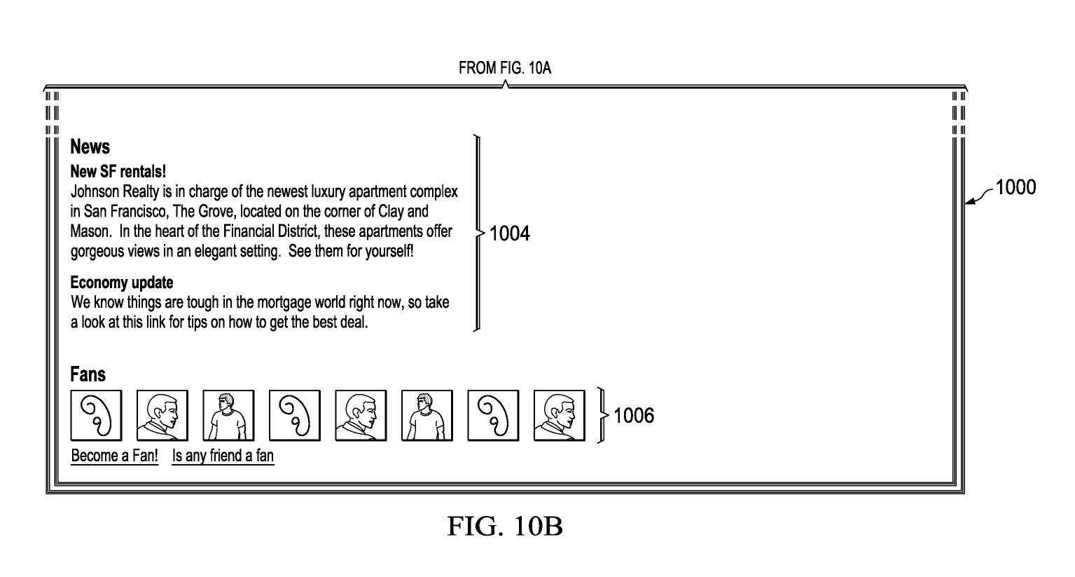

The described approach provides for free-form text entry without categories or fields in posted Needs (see, e.g., FIG. 4 and accompanying text), and similarly provides for free-form text entry in NeedTrackers and NeedCatchers (see, e.g., FIG. 11 and accompanying text). Further to the concept of free-form Need text entry, the system 120 does not require that a user follow a pattern such as an application form or the like. However, the system can propose to the user (optionally based on feedback received from the user) information the user should provide in a Need, NeedCatcher, NeedTracker, Help, or Pro-help. For example, a user may post a Need with the subject “apartment,” and the disclosed system 120 might suggest optionally providing information such as “rooms, floors, budget, etc. . . . ”

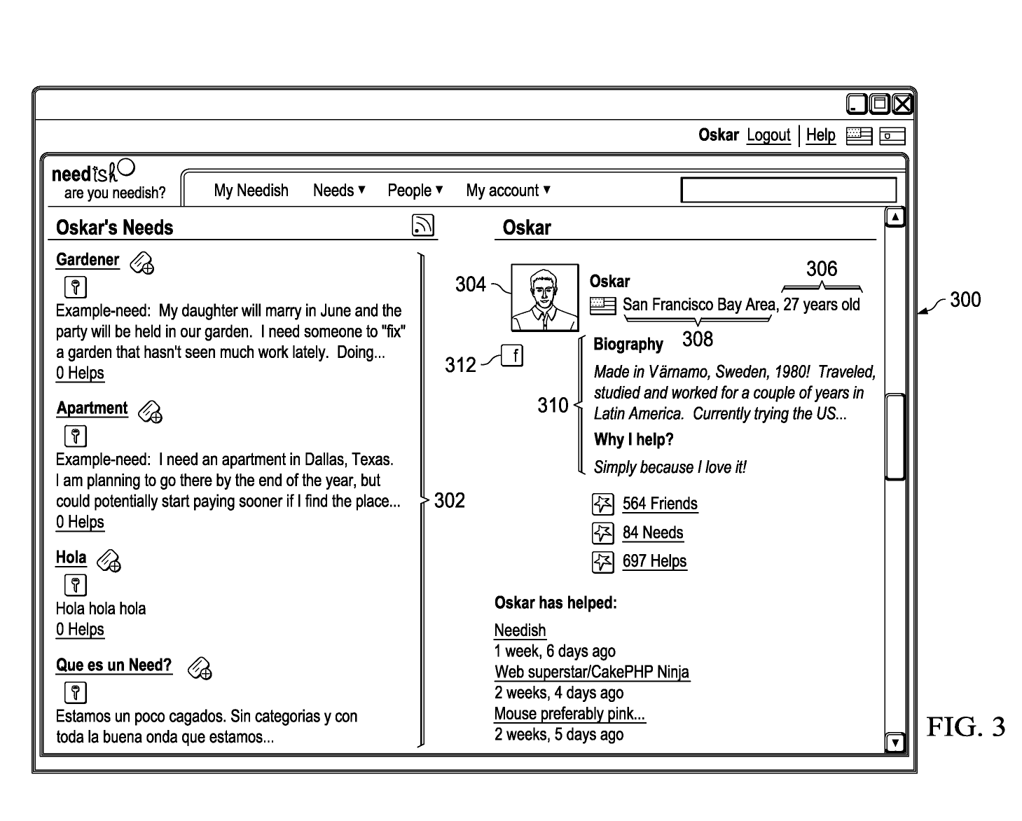

Users without accounts, or “Visitors,” can access the disclosed system 120 with limited functionality. Visitors can view the system as a current and local information-exchange for information regarding products and services and/or as a company directory without having to register as a user. To create Needs, NeedTrackers, and NeedCatchers, and to provide Help and to harness the inherent power of the social network (e.g., seeing Fans of companies), visitors should create an account. Accounts created within the system may be customizable by the user or an administrative user. The process and particulars for creating and editing user profiles are further described below in FIG. 3 and its accompanying text.

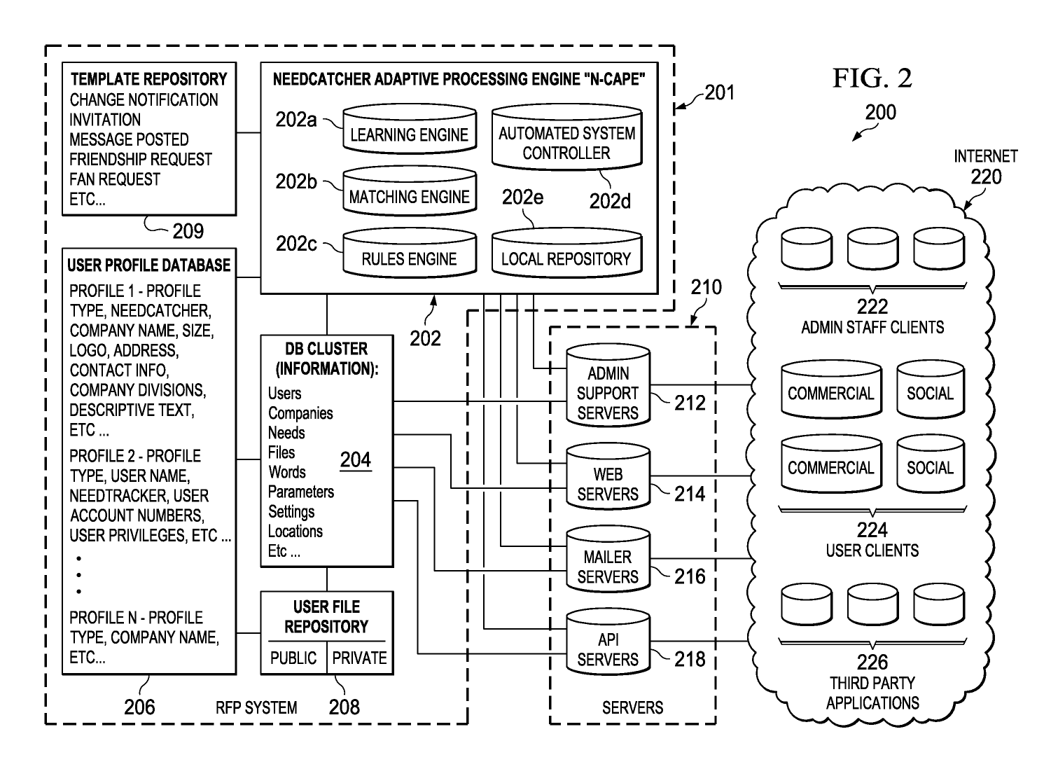

FIG. 2 provides an exemplary system diagram 200 illustrating the various elements of the disclosed system. Included in the system diagram 200 are the RFP System 201, Servers 210, and Internet 220. The RFP System 201 includes the NeedCatcher Adaptive Processing Engine (N-CAPE) 202, Learning Engine 202a, Matching Engine 202b, Rules Engine 202c, Automated System Controller 202d, Local Repository 202e, Database Cluster 204, User Profile Database 206, User File Repository 208, and Template Repository 209. The Servers 210 include Administration Support Servers 212, Web Servers 214, Mailer Servers 216, and API Servers 218. The Internet 220 provides access to and from the disclosed system 120 for administration staff client machines 222, user client machines 224 (for both commercial and social users), and third-party applications 226.

The N-CAPE 202 comprises a Learning Engine 202a, Matching Engine 202b, Rules Engine 202c, and Automated System Controller 202d, and is responsible for communicating with the elements illustrated in the system diagram 200 to provide the processing and learning capabilities of the disclosed system 120. The N-CAPE 202 communicates with the User Profile Database 206, Database Cluster 204, and Template Repository 209 to store, access, retrieve, and/or update information stored in the User Profile Database 206, Database Cluster 204, and the Template Repository 209. The N-CAPE 202 also receives input from, and provides information to, the Servers 210.

The Learning Engine 202a, Matching Engine 202b, Rules Engine 202c, Automated System Controller 202d, and Local Repository 202e all work together to provide the core functionality of the NeedCatcher Adaptive Processing Engine 202 of the disclosed system. The Learning Engine 202a provides flexibility of the system by adjusting and adapting different elements of the system to retained, or “memorized” circumstances. For example, the Learning Engine 202a may “learn” that a particular user prefers to display only his Needs and not his NeedCatcher in his profile. Once the system has been informed of that preference, the Learning Engine 202a memorizes that setting, and works with other elements of the system to ensure that the user only sees his Needs and not his NeedCatcher when viewing his profile. The Matching Engine 202b is responsible for matching information such as the subject, description, and metadata of Needs and NeedCatchers/NeedTrackers, and determining the relevance of the matches. The Rules Engine 202c is responsible for the access and restrictions set for user accounts. In other words, the Rules Engine 202c keeps users from accessing information beyond their privilege settings. The Local Repository 202e provides for local storage of data that may be used by the elements of the N-CAPE 202. The Automated System Controller 202d provides the automated functionality of the system, and is responsible for receiving, sending, and searching data without human intervention. For example, if the N-CAPE receives a request for an invitation to be sent to a user, the Automated System Controller 202d receives the request, and works with the other elements of the N-CAPE 202 to retrieve an invitation template from the Template Repository 209. Information included in the invitation request is extracted by the Automated System Controller 202d and is stored in the Local Repository 202e. Once the invitation template is received by the Automated System Controller 202d, the extracted data is retrieved from the Local Repository 202e and inserted into the invitation, before being sent to the invited user.

The Database Cluster 204 is responsible for storing information received from the N-CAPE 202 and Servers 210. Such information may include user, company, Need, location, setting, and profile metadata, as well as files, words, images, parameters and other information stored within the disclosed system 120. The Database Cluster 204 also shares metadata with the User Profile Database 206 and User File Repository 208. Some of the information stored in the Database Cluster 204, User Profile Database 206, and User File Repository 208 may be interchangeable, or stored in each location.

The User Profile Database 206 contains a register of all user profiles, and includes user profile data and the metadata specific to each user profile. The profile data may include the user's name, Need information, NeedCatcher/NeedTracker information, company information, profile settings, and any other information or data that is relative to the user profile. The metadata specific to the user profile may include profile type, user/company name, contact information, address, or any other information that may be relevant to the user profile or account. The User Profile Database 206 communicates with the Database Cluster 204 and User Profile Repository 208 to store information submitted by, or collected about, a specific user. As previously stated, some of the information stored in the User Profile Database 206 and User Profile Repository 208 may be interchangeable or stored in both locations.

The User Profile Repository 208 consists of a private section and a public section. Any data, files, attachments, Help, Pro-help, NeedCatchers/NeedTrackers, or Needs submitted or uploaded by the user are stored in the private and/or public sections of the User Profile Repository 208. The data in the User File Repository 208 are user-specific, but may be retrieved or accessed by other users if the data are stored in the user's public section. If the data in the User File Repository 208 are stored in the accessed private section, then only users with proper credentials (as determined by the accessed user and/or the accessed user's profile) are allowed access to the data.

The Template Repository 209 stores templates of notifications that are sent to users. Examples of the templates stored in the Template Repository 209 may include change notifications, invitations to the system, notification of messages, friendship requests, and other generic notifications that may be sent to a user. The Template Repository 209 may be accessed by the N-CAPE 202 when a generic notification or message is sent to a recipient.

The Administration Support 212, Web 214, Mailer 216, and API 218 Servers make up the Server platform 210, and provide communication between the Internet 220 and the Database Cluster 204 and N-CAPE 202 as illustrated in FIG. 2. Information received from the administration staff client machines 222, user client machines 224, and/or third-party applications 226 accessing the disclosed system 120 through the Internet 220 is handled by the Servers 210, and distributed to either the N-CAPE 202 or the Database Cluster 204. Information received from either the N-CAPE 202 or the Database Cluster 204 is sent by the Servers 210 to the administration staff client machines 222, user client machines 224, and/or third-party applications 226 accessing the disclosed system 120 through the Internet 220.

FIG. 3 provides an exemplary user profile 300, including a list of the user's Needs 302, an uploaded picture 304, the user's age 306, the user's location 308, descriptive text 310, and links 312 to the user's presence in other social networks. These described fields are merely exemplary, and much information can be gathered from a user when the user creates an account. Depending upon the account created, information gathered from the user setting up the account, and/or about the user's activities for the account, is stored in the Database Cluster 204 as metadata related to the user's account (account metadata), or is stored in the User Profile Database 206 as metadata specific to the user's profile (profile metadata).

The process of account generation itself and/or the user's activities associated with the account can be used to generate metadata about the user's account. General information gathered from the user can include, but is not limited to, user gender, age, and location. A user opening a commercial account may wish to further include account information such as the company's name, the user's position within the company, defined pre-negotiated deals with vendors, functionality for open and closed bidding processes, administrative roles with different access for the users, quality control capabilities and standards, as well as other features that may be useful for companies in buying or purchasing modules. Once a user account is created, the account, and the metadata related to the user account, is stored in the Database Cluster 204.

As previously stated, profile data may also be related to the user account, wherein the types of data profile stored will correspond to the type of account opened by the user. For example, a social user account may contain a social user profile, while a commercial user account may contain a commercial user profile and/or company profile. Further, an administrator account may contain an administrator profile.

Additional information may be provided by users for inclusion in their profile. For example, a user opening a social account may wish to provide their income, address, other user account numbers, or other relevant information. Users opening commercial accounts may wish to include information such as the company's name, size, logo, taxpayer identification, address, contact information, divisions within the company, descriptive text, and other information that may be useful within the company profile. A user may further customize a profile by uploading an image, providing descriptive text, or providing links to the user's presence in other social networks. Once a user profile is created, the profile, and all metadata related to the user profile, is stored in the User Profile Database 206.

The metadata generated from the user's information contains data about the user's account and profile, and is typically used to provide definitive data in filtering schemes within the system. For purposes disclosed with this application, metadata is considered data pertaining to a set of data, is definitive (and may be read and understood by a machine with no word “weighting” or value assignment) and may be used for searching/comparison purposes. For example, a user may wish to request Help from commercial users representing a company that generates at least a specified amount of revenue. To filter the users whose NeedCatchers or NeedTrackers receive this Need, information is required from potential recipients of the Need. In addition to typical search criteria, such as relevant words and geographical content, the system 201 will consider whether a user represents a company, and if so, if the company's revenue meets the criteria specified in the filtering scheme. This information is found by searching the metadata in the User Profile Database 206 for profiles with matching criteria. Metadata provides for efficient filtering because the metadata is easy for a machine to read and interpret, thus allowing the machine to quickly determine if the specified search criteria is satisfied.

Users with authorization may also create administrator accounts 222, wherein the administrator account has all the functionality of a social or commercial account, plus extra privileges allowing the administrative user to run and operate the disclosed system and/or to administer the accounts of multiple social or commercial user clients 224.

### Social Users

As illustrated in FIG. 4, posting a Need is very similar to sending an email, making the process simple for the user. Users post Needs using free-text fields for the subject and description of the Need. The exemplary Need template 400 in FIG. 4 includes a “Subject” line 402, wherein the user posting the Need enters text briefly describing the Need in which Help is sought. The template 400 also includes a free-text “Description” box 404 in which the user can elaborate on the subject, and an attachment option 406 wherein the user can upload files such as written information, documents, pictures, or other attachments for inclusion in the Need. The Needs are submitted through the user client machine 224 through the web server 214, and are then analyzed by the Matching Engine 202b in the N-CAPE 202 for the best match or matches according to the methods described below.

Further included in the exemplary template 400 are links to optionally change and specify settings for particular geographic regions 408 in which the goods or services are desired and the timeframe 410 in which the user is interested in receiving Help. Users may also choose to modify default options for the Need such as the Need's privacy level using an “Advanced Options” tab 412. A privacy setting gives the user the option to display a Need (as well as the responding Helps) and/or the private profile related to a Need only to Friends and/or users with company profiles, depending on the privacy settings selected by the user posting the Need. Other default settings the user can change may include maximum number of Helps requested for the Need, number of days the Need is valid for receiving Helps, and whether or not other users can see private Pro-helps.

Users posting Needs may also customize a filter to control which users view a posted Need by restricting viewing users' access based on specified criteria. Criteria used to filter such receiving users may include, but are not limited to, minimum or maximum revenue (for users with company profiles), minimum or maximum profitability (again, for users with company profiles), geographic location, language, specific users, users with or without ratings within the system, users with minimum ratings, and companies with certain criteria available in the vendor's profile. Users creating a Need may also target specific users to provide Help by sending the Need directly to that user.

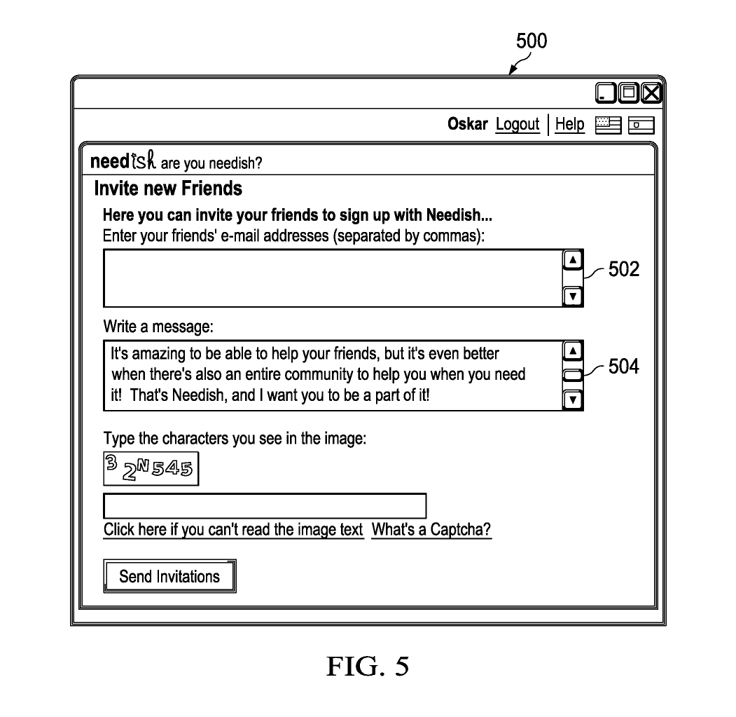

Users may invite people to become new users of the disclosed automated system 201 by accessing the request for an invitation template 500 illustrated in FIG. 5. The request for an invitation template 500 includes a recipient field 502 to enter email addresses and a free-text field 504 to include an optional message. Users enter email addresses in the address field 502, and an invitation is sent to those email addresses. The requests for invitations are submitted through the user client machine 224 through the web server 214, and are then analyzed by the Automated System Controller 202d in the N-CAPE 202. The recipients' email addresses and the optional messages are extracted from the request for an invitation and stored in the Local Repository 202e and the inviting user's User File Repository 208. The Automated System Controller 202d then retrieves the invitation template from the Template Repository 209. The extracted data is then retrieved from the Local Repository 202e and inserted into the invitation template. The invitation is sent through the mailer server 216 to the recipients' email addresses, and includes a link directing the invitee to the system, and the optional free-text message if the user initiating the invitation included it.

During or after the timeframe during which Helps are requested, the user who posted the Need can access an interface to view, evaluate, and comment on all incoming Helps. Functionality during the evaluation process may include providing feedback to a user providing a Help, requesting more information from the helping user, updating the Need (this will show the updated information to all other users viewing the Need), and chatting back-and-forth with one or several of the users providing Helps.

When searching for a Need or when a new Need appears in a user's list based on a NeedTracker or a NeedCatcher, the user can take the following actions, as examples:
1) Remove the Need from the list. This indicates to the automated system 120 that the Need is not interesting or relevant to the user. The user can optionally notify administrative users why the Need is not interesting or relevant such that the system may be improved in general, or modified for that specific individual.
2) Put the Need on hold. The Need may be put on hold for various reasons, for example:
   User with a company profile may want to be notified if this Need has no offers in X more days or Y days before it expires.
   User with a company profile may want to remove it from the new Needs list but still be able to view it at a later date.
3) Submit a Help to the user posting the Need. A user with a company profile may choose each time it submits a Help if it is submitting the Help as a private person or as a representative of the company associated with their account.
4) Users with company profiles may submit Pro-helps to users posting the Needs:
   Optionally using free-text and selections to change default preferences.
   Optionally using the user profile to set estimated prices by item, week, month etc. . . .
   Optionally using template Helps in combination with free-text (for customizable changes).
   Optionally using previously submitted Helps (not necessarily to that specific user posting a Need) that have been made for similar Needs. The previously submitted Help is stored in the User File Repository 208.
   Optionally using uploaded files and documents. These uploaded files and documents are stored in the User File Repository 208.
   Optionally using the ability to make some of the Pro-help public, and some private.

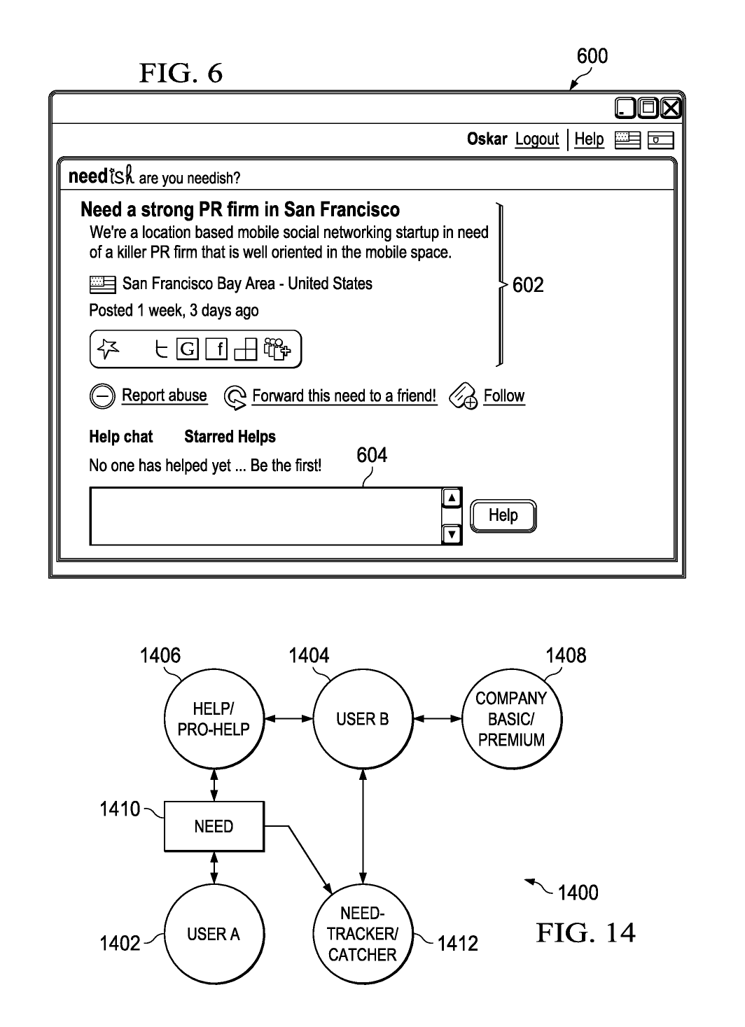

A Help is typically submitted as a response to a posted Need as illustrated by the exemplary Need post 600 in FIG. 6. The exemplary Need post 600 features a Need 602 as posted by a Needy user, and a free-text Help box 604. Users wishing to submit a Help simply enter information in the Help box 604, and the Help is sent to the user that posted the Need 602. The Help is submitted through the helping user's client machine 224 through the web server 214, and is then analyzed by the Automated System Controller 202d in the N-CAPE 202. The Help is then stored in the User File Repository 208 of both the Needy user's and the helping user's profiles with the User Profile Databases 206. When the Needy user accesses their profile from the user client machine 224 through the web server 214, the Help is visible to the Needy user. Notification of the Help may be sent as a generic email pulled from the Template Repository 209 by the Automated System Controller 202d of the N-CAPE 202, and sent through the mailer server 216, to the user client machine 224 of the Needy user if their settings permit receipt of such notification.

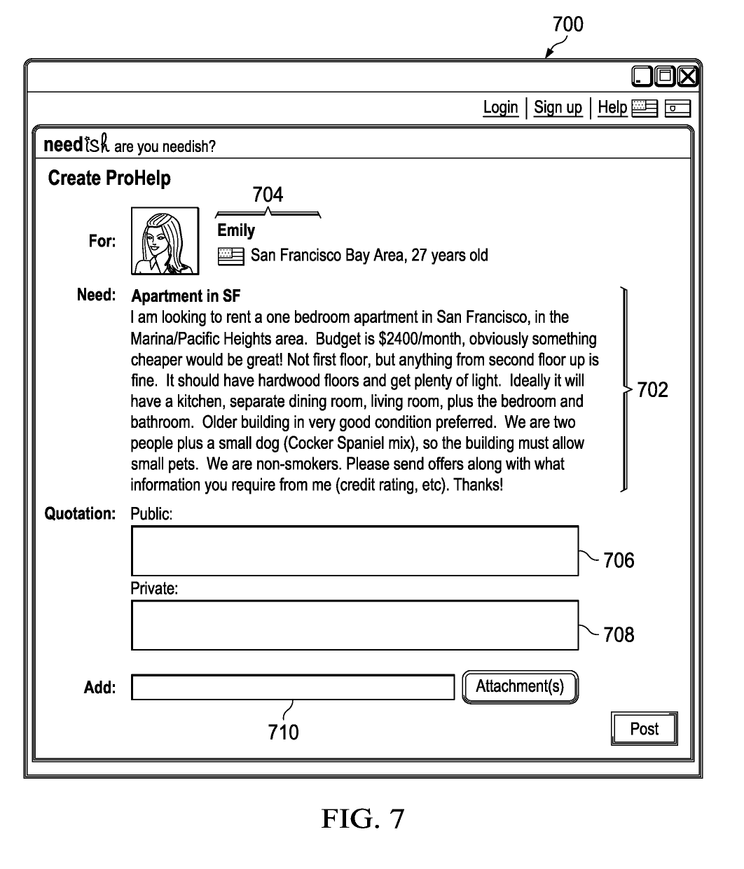

Pro-help is similar to Help, but provides greater functionality, and is usually submitted by a commercial user with a premium profile. The Pro-help differs from a basic Help by offering the helping user the option to attach objects, files, etc. . . . and to make some, all, or none of the Pro-help private. An exemplary Pro-help response 700 is illustrated in FIG. 7, wherein a Need 702 is posted by a Needy user 704. Users wishing to offer Pro-help to the Needy user 704 are presented with two free-text boxes 706, 708 wherein the user offering Pro-help may enter information. One of the free-text boxes is a public Pro-help box 706, wherein information entered in the public Pro-help box 706 is visible to all users. The other free-text box is a private Pro-help box 708, wherein information entered in the private Pro-help box 708 is only visible to the Needy user 704 posting the Need 702. Further included in the Pro-help response 700 is an attachment box 710, wherein the user submitting Pro-help may upload attachments to the Pro-help. The Pro-help and any attachments are submitted through the helping user's client machine 224 through the web server 214, and is then analyzed by the Automated System Controller 202d in the N-CAPE 202. The Pro-help and attachments are then stored in the User File Repository 208 of both the Needy user's and the helping user's User Profile Databases 206. If the Pro-help or Need is private, then the Pro-help and any attachments included in the Pro-help are stored in the private section of the User File Repository 208. If the Pro-help and Need are public, then the Pro-help and any included attachments are stored in the public section of the User File Repository 208, and thus are visible to any user that can access the Need or Pro-help. When the Needy user 704 accesses their profile from the user client machine 224 through the web server 214, the Pro-help 700 is visible to the Needy user 704. Notification of the Pro-help may be sent as a generic email pulled from the Template Repository 209 by the Automated System Controller 202d of the N-CAPE 202, and sent through the mailer server 216, to the user client machine 224 of the Needy user if their settings permit receipt of such notification. Because the Pro-help and attachments are stored in the User File Repository 208 and the User File Repository 208 may be accessible by other users, any user that has access to the Pro-help (if the Pro-help/Need is private the accessing user must have proper credentials), also has access to the posted Need and any attachments that were included in the Pro-help.

Once a Help is submitted, the user submitting the Help may be notified of any events such as if the Need has been changed (Help can be updated accordingly) or if the user that posted the Need has sent a message to the user submitting the Help. The notification of a change or posted message is generated from a template stored in the Template Repository 209. The template of the change or message notification is pulled from the Template Repository 209 by the Automated System Controller 202d of the N-CAPE 202, and sent through the mail server 216, to the user client machine 224. The change or message notification is also stored in the User File Repository 208 of the user receiving the notification.

Once a Pro-help has been submitted, functionality is the same as when standard Help has been submitted (e.g., user can respond to the Help, contact the helping user, etc. . . . ), but with the difference that when the Need is closed, the user providing the Pro-help can also provide feedback to the system. Such feedback may include, but is not limited to, whether or not the client accepted the submitted Pro-help, and comments for future benchmarking or statistics that may be tracked by that user. Feedback may be submitted from a user client machine 224 through the web server 214, and is then analyzed by the Automated System Controller 202d of the N-CAPE 202. The feedback is then sent through the administration support server 212 to administration staff client machines 222 where it is accessed by an administrative user. The administrative user then has the option to ignore the feedback, or act upon the feedback by, for example, adjusting the automated system according to the feedback, or adjusting the profile or settings for the user providing the feedback. The response to the feedback is at the discretion of the administrative user, and may include actions other than those disclosed herein.

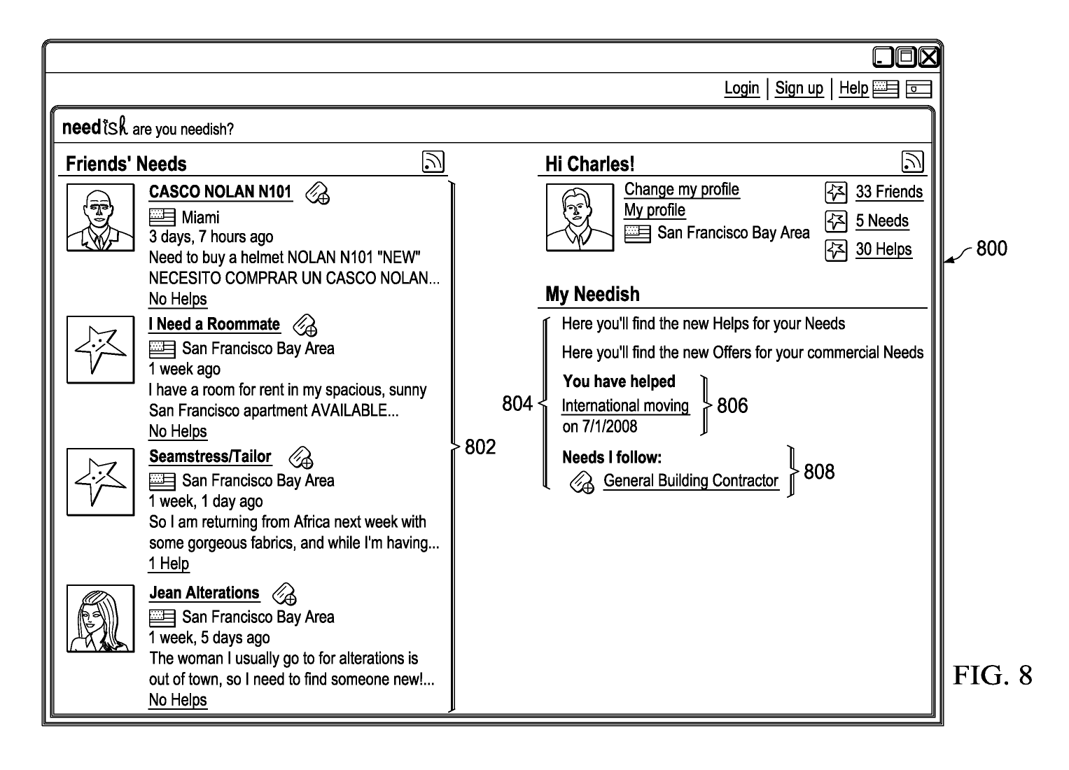

When viewing his or her profile, a user can view his or her Friends' Needs 802 and an overview of the user's latest usage 804 in the system, including Needs where the user has helped 806, as well as Needs that the user is following 808, as illustrated by the exemplary user profile 800 in FIG. 8. Also visible in the user's profile are the Needs matching the user's NeedTracker(s) or NeedCatcher(s). The user profiles and data related to the profiles are stored in the User Profile Database 206, which includes such profiles for all users.

### Commercial Users

FIG. 9 illustrates an exemplary basic company profile 900, including the company's name 902, logo 904, contact information 906, address 908, miscellaneous information 910, and a description of the company 912. The exemplary profile 900 further includes links to related businesses within the system 914. Any user may create a standard commercial or company profile within the disclosed system, even for a company to which the user has no prior relation. As previously mentioned, the user may be someone who wants to endorse that company's service by becoming its Fan. A user may create a standard company profile as “the user's company” or take ownership of a company already created within the system, such as by clicking a “this is my company” button. The creation or changing of a new or existing standard profile is subject to approval of the disclosed automated system, shown as the “NeedCatcher Adaptive Processing Engine 202,” or N-CAPE, which would use its Learning Engine 202a, Matching Engine 202b, Rules Engine 202c, and Automated System Controller 202d for verifying the user's ownership of the company profile.

As previously stated, the basic information included in a company profile could include, as examples, a company name, logo, brief information (e.g., text included in all future offers), address, and contact information. The user creating the profile can also add more information—information that could be required by a user posting a Need, such as company size (revenue and employees), reference cases or testimony, a copy of the company's annual statement, or other relevant information/documents for consumers and businesses purchasing services or products. Again, the information included in a company profile is stored in the User Profile Database 206, while the attachments, and other documents are stored in the User File Repository 208 associated with the user profile in User Profile Database 206.

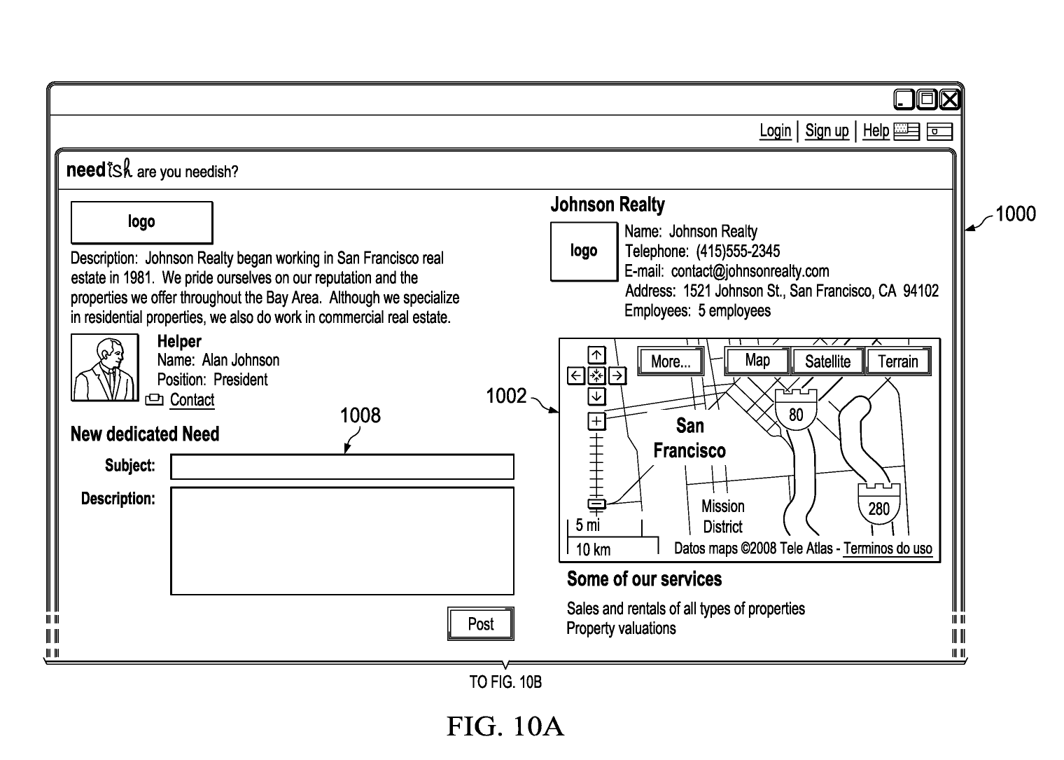

Users with a basic company profile may upgrade their profile to a premium company profile. The premium profile allows for extra (premium) features, as well as a customizable premium presentation. FIG. 10 illustrates an exemplary premium company profile 1000 including the features in a basic company profile. The exemplary premium company profile 1000 further includes a map of the company's location 1002, a local news feed 1004, a listing of Fans 1006, and a dedicated Need 1008. The premium profile is flexible, and is typically designed or customized by the user of the premium profile. The profile settings are stored in the User Profile Database 206.

The premium profile offers many different ways of representing a company, and is not limited to the features shown above. A premium profile provides for a user representing a company when accessing the disclosed system. The premium profile is more valuable than the basic profile because of the upgraded profile itself as well as the additional included premium features. Premium features may include, but are not limited to:
The ability to submit Pro-helps.
The ability to create one or more NeedCatchers.
The ability to communicate with Fans by providing direct communication to the Fans.
The ability to post information about special services for all users (not just Fans).
The ability to link several users (e.g., employees) to the company profile and to create a company organization, which includes functionality such as:
   Creating a corporate structure using tools to build a copy of the company's organization.
   Adding resources to one or more divisions, NeedCatchers or a combination thereof.
   Administrating roles with different access and privileges.
   Creating sales teams for various sales projects.
   Delegating offers/sales cases.
   Letting managers approve information going out to Buyers.
   Generating sales reports.
   Adding general Customer Relations Management (CRM) functionality to compete with CRM providers.
   Other functionality from a sales and/or CRM system.
The ability to create Pro-help templates, for quicker posting.
The ability to receive dedicated Needs, which are more qualified “Leads” than posted regular Needs.
The ability to generate reports on the company's usage in the disclosed system.

Examples of premium preference settings include but are not limited to:
Allowing open bidding between Vendors on products and services by showing private sections of Pro-helps to other users (Vendors) posting Pro-helps.
Only receiving Needs with a minimum and/or maximum number of wanted Helps.
Only receiving Needs with a minimum and/or maximum timeframe (Need expiration date).
Optionally receiving e-mail notification of new Needs matching a NeedCatcher.
Optionally receiving e-mail notification of changes to a Need in which Help has previously been submitted.
Only receiving Needs from Buyers with certain characteristics based on information posted by the Buyer.

A company may use the disclosed system not only for administrating RFP processes, but also for more advanced processes. Added functionality may be provided to commercial users, wherein the added functionality includes, but is not limited to:
Corporate Accounts reflecting the organizational structure with department, subdivisions, business lines etc. . . . This may be included in the company profile as a directory showing a break-down of the company by department, branch, division, etc. . . . Each department may also include users that are assigned to that department within the company. The organizational structure is entirely customizable. A company profile with an organizational structure allows security features to be adapted to the organizational structure, allowing different rights to different users. The different rights allocated to different users are handled by the Rules Engine 202c of the N-CAPE 202 working in communication with the User Profile Database 206.
Adding staff members to different parts of the organization. The staff members are typically users of the disclosed system that are given specific rights to the company profile. The rights may be restricted based on the staff members rank/position within the company, or as otherwise determined by the user owning the company profile.
Giving different rights to different users. As stated above, the user owning the company profile may determine which rights to grant to different users. For example, a user may be granted the right to view outgoing Help before it is posted, but that same user may be unable to submit the Help to the Needy user. Again, the rights are controlled by the Rules Engine 202c of the N-CAPE 202.
Allowing elements of the system (e.g., a posted Need, or communication between a company user and a user not affiliated with the company) to be approved by a manager before being activated in the system.
Defining pre-negotiated Vendors/Deals. The pre-negotiated deals may be listed in the company's profile as a product with a given price.
Allowing groups of users to rate and evaluate offers. The company profile may include a text-box, pre-defined ranking system, or other form of communication in which users can indicate their satisfaction with a posted offer (e.g., a pre-negotiated deal listed in the company's profile) or submitted Need.
Inviting Vendors to make presentations. A Vendor may be able to provide a short advertisement or commercial to be included in the company profile, or to be sent to all users with relevant needs, or fans of the company.
Allowing payment online. A transactional service may be included in the company profile.
Providing support for shipping. A company may provide support for shipping the product by providing the Needy user with a courier.
Providing functionality for open and closed bidding processes. The company may provide a bidding system within the company's profile in which users can submit an offer for a product or service. The bidding process may be open to all users, or only to specific users (closed), such as Fans of the company.
Allowing invitation-only RFPs in which only Needs that are specifically sent to the company are received. This reduces the amount of Needs received by a company, and may be used as a way to decrease “spam” Needs, or Needs that are not specific to the company.
Integration to other systems, including third party systems. A company may have profiles associated with other systems, such as other social platforms, or the company's own personal website. Links to the other systems or platforms in which the company is involved may be included in the company's profile. Access to the third party system may be provided by a link directing a user from the company's profile to the third party application 226 through the API server 218.
Purchasing reports, such as a list of users that have made a purchase from the company within the last six months, or a report of how many users purchased a specific product or service, etc. . . . The data found in these reports are stored in the User Profile Database 206, Database Cluster 204, and User File Repository 208.
Other features that would be useful to companies in a buying module.

### NeedTrackers and NeedCatchers

NeedTrackers and NeedCatchers can be understood as a subscription to buying signals (RFPs) relevant to a product or a service a user provides. As illustrated in FIG. 11, a NeedTracker 1100 contains collections of words and data 1102 defined by a user, wherein the words and data 1102 generally relate to services, products, or general information in which the user is interested in providing to other users. The exemplary NeedTracker 1100 in FIG. 11 illustrates a free-text word field 1104, wherein users enter the collection of words and data 1102. NeedTrackers are usually implemented by the user as a way to receive posted Needs that are relevant to the words and data 1102 defined in the user's NeedTracker 1100. NeedTrackers also include optional location fields 1106 providing the user with the ability to define one or several locations or geographical areas 1108, where the product or a service may be available.

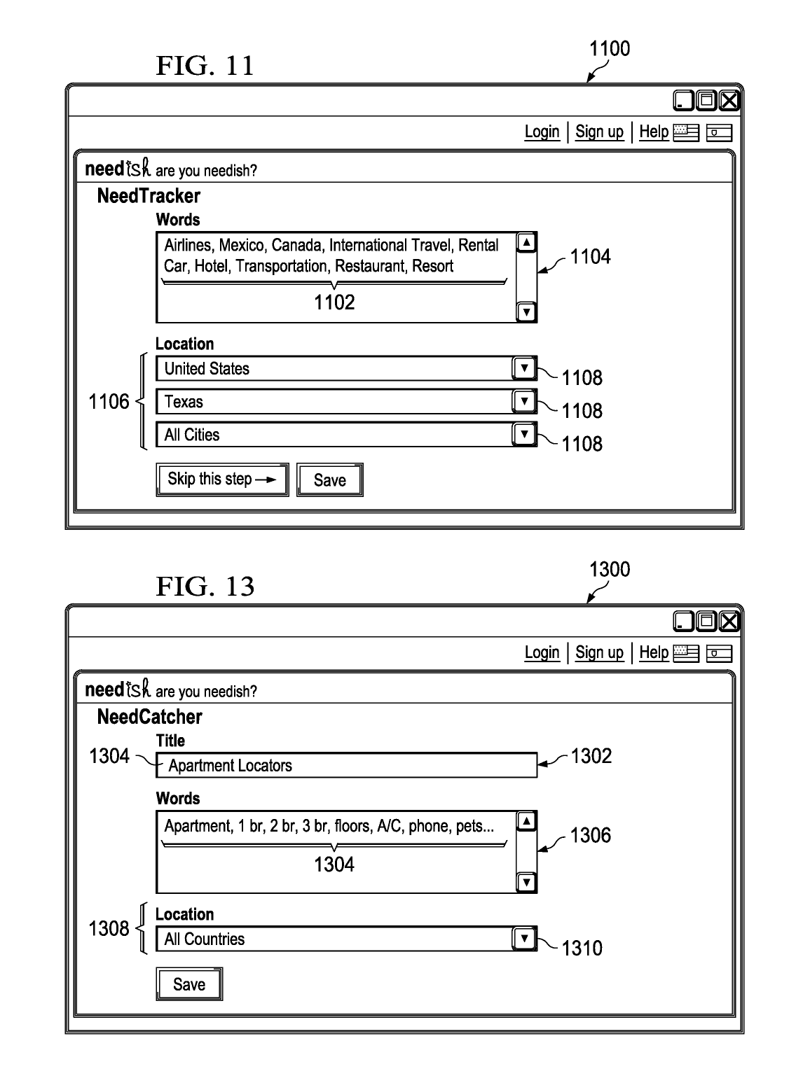

When a NeedTracker or NeedCatcher is created by a user, it is stored in the user's profile in the User Profile Database 206. The N-CAPE 202 searches the User File Repository 208 and User Profile Database 206 for users with Needs that are relevant to the defined NeedTracker/NeedCatcher. The system uses the Matching Engine 202b to match the words and data 1102 in a user's NeedTracker with posted Needs—word-by-word—and creates a list of all matching Needs in the system. Additionally, the Matching Engine 202b checks the profile of the user creating the NeedTracker or NeedCatcher to determine if the user creating the NeedTracker or NeedCatcher has specified criteria for filtering Needs. For example, a user may choose to reject or block Needs submitted by a specific user. The name (or other identifying information) of the user to be blocked, and any other filtering criteria, can be stored in the user profile of the user defining the filtering criteria for the NeedCatcher or NeedTracker. When the Matching Engine 202b checks the profile of the user defining the NeedTracker or NeedCatcher for any filtering criteria, it will notice the blocked user, and will not include Needs posted by the blocked user in the matching Needs lists. The list of matching Needs is stored in the Local Repository 202e, User Profile Database 206, and User File Repository 208. If the user included the optional geographical data 1108, then only matching Needs within the defined geographical location 1108 are included in the list. As previously stated, the list of relevant or matching Needs is included in the user's profile as illustrated in FIG. 12. The NeedTracker list 1200 of FIG. 12 includes a list of Needs 1202 corresponding to the data listed in a user's NeedTracker. Similar to the method described above, when a user creates a Need, their Need is stored in the user's User File Repository 208 and User Profile Database 206, and is matched (using the Matching Engine 202b of the N-CAPE 202) with existing NeedTrackers within the User Profile Database 206 and User File Repository 208. The Need is then sent to the accounts of the users with matching NeedTrackers, and stored in their User Profile Databases 206 and User File Repositories 208.

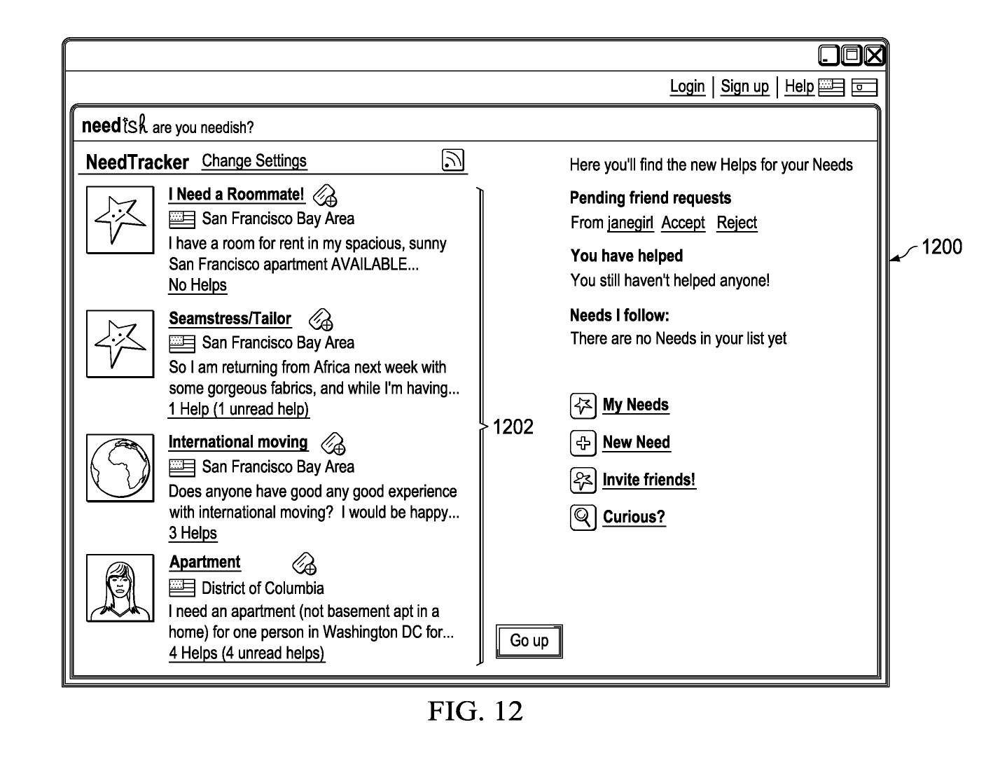

For a more advanced matching procedure, the user can create a NeedCatcher. A NeedCatcher is similar to a NeedTracker in functionality, but provides for more refined searching and filtering by including more data fields to search and match. As illustrated in FIG. 13, a NeedCatcher 1300 consists of a free-text title field 1302 and collections of words and data 1304 defined by a user, wherein the words and data 1304 generally relate to services, products, or general information in which the user is interested in providing to other users. The exemplary NeedCatcher 1300 in FIG. 13 illustrates a free-text word field 1306, wherein users enter the collection of words and data 1304. Again, NeedCatchers are usually implemented by the user as a way to receive posted Needs that are relevant to the words and data 1304 defined in the user's NeedCatcher 1300. NeedCatchers also include optional location fields 1308 providing the user with the ability to define one or several locations or geographical areas 1310, where the product or a service may be available.

NeedCatchers are associated with the core matching technology of the disclosed system, and are the solution to a non-category approach to matching RFPs with companies' profiles. Disclosed is a description of the technology and constant improvement of that technology, used to maintain a relevant “match” between the RFPs (Needs) and companies' profiles or accounts.

One of the characteristics of the disclosed system is its capability to match a Need with one or more NeedCatchers. Again, an RFP/Buying signal is represented in the system as an object called a Need. Users can subscribe to these Needs using an object called a NeedCatcher.

The N-CAPE 202 uses its Matching Engine 202b to match a NeedTracker with all Needs that have at least one matching word. The same operation is performed for a NeedCatcher, but especially relevant Needs are also estimated and filtered, and stored in the Local Repository 202e and User File Repository 208 as a separate list, distinguished from all other matched Needs. That list of especially relevant Needs is described hereinafter.

A Need is composed of:
Subject: A short free-text describing the necessity.
Description: A larger free-text and a detailed description of the necessity.
Metadata: One or more defined parameters, including, but not limited to, data such as date, location and maximum expected Helps.
   In the same way, a NeedCatcher is composed of:
Subject: A set of keywords that summarize the service or product.
Description: Free-text and a detailed description of the service or product provided.
Metadata: One or more defined parameters, including, but not limited to, data such as location and Buyer characteristics (wherein the user creating the NeedCatcher is the Buyer).
   Given a specific Need, the disclosed system will sort NeedCatchers by relevance and match the Need to NeedCatchers based on their relevance, provided that the filtered metadata offers a match. Given a NeedCatcher, the system will provide relevant Needs to users interested in subscribing to them as stated above.

### Administrative Support

The capability of the system to determine the correct relevance of a NeedCatcher to a given Need or the correct relevance of a Need to a given NeedCatcher is a core functionality of the system. “Correct relevance” refers to the system's ability to reflect the potential of a user with a company profile (represented by a NeedCatcher) to satisfy a user's Need, or the potential of a user (represented by a Need) to become a user of a company's services (represented by a Help).

In order to estimate the relevance, the system uses a hybrid approximation based on administrative support, and an automated algorithm implementation of the NeedCatcher. The automated algorithm is included in the Matching System 202b of the N-CAPE 202. As illustrated in FIG. 2, a team of administrative users can manually estimate the relevance as required by accessing the Matching Engine 202b through the Administration Support Server 212 from the administration staff client machines 222.

To support the disclosed system, administrative support is implemented for content management, processes, and algorithm improvement. The following is a list of ways that administrative support is implemented:
Actively recruiting users to subscribe to the system and offering their products and services to Needs that don't have matching NeedCatchers in the system.
Communicating with users to determine the relevancy of a Need that has been delivered to the user's NeedTracker/NeedCatcher, and providing feedback to development, for constant improvement of algorithms.
Manually “matching” a Need to one or several NeedCatchers.
Labeling individual words (by language) to give them attributes for use in filtering. Words may be given an attribute that indicates that the word is part of a spam message, company name, description, etc. . . .
Adding metadata to Needs or NeedCatchers to improve the chances of their matching, and providing the system with relevant information, allowing it to adapt and improve the overall quality of service. Examples of this may include marking a Need as social or commercial, or relating a Need or NeedCatcher to one or several industries or categories.
Monitoring usage of the system to assure quality of service and content. For example, ensuring non-foul language and making sure all users receive relevant feedback/help/support when needed.
Supporting and chatting with users.
   The Administrative Support Server 212 is an internal module guiding administrative users through all tasks involved in administrative processes, by locally (based on location and language of Need) pushing information and duties to administrative users.

### Functionality

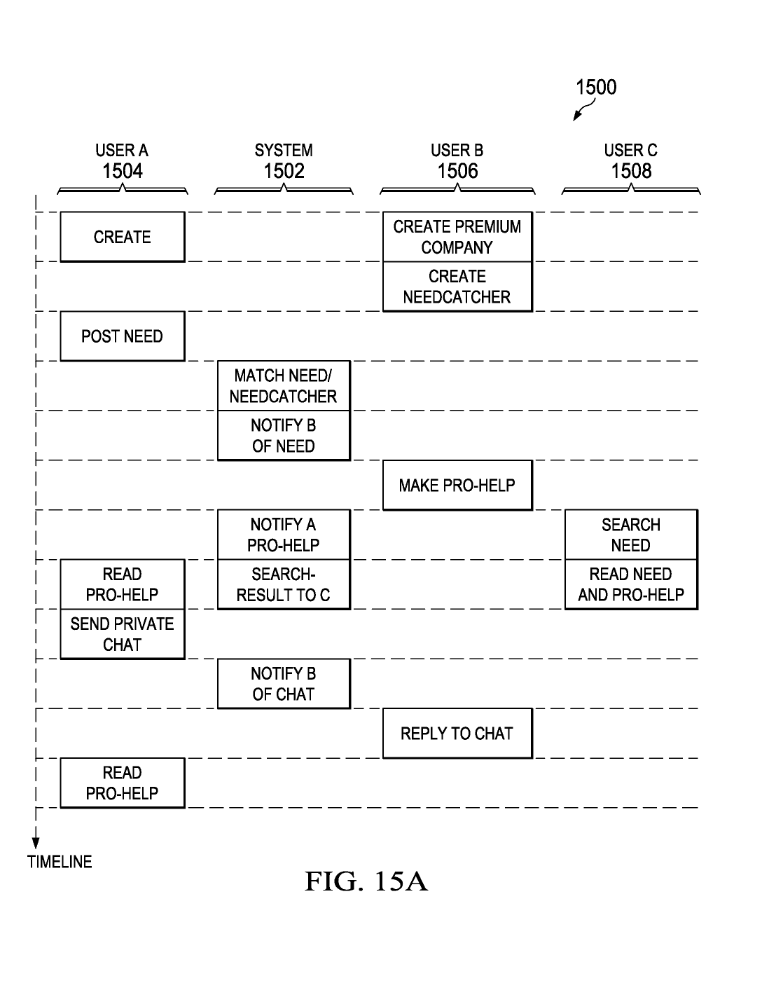

FIG. 14 illustrates a flowchart 1400 of the functionality of the disclosed system. The flowchart 1400 illustrates the relationship between User A 1402, User B 1404 and the Help 1406 posted by User B 1404, as well as the company profile 1408 that User B 1404 is related to. Additionally, the relationship between User A 1402, the posted Need 1410, and User B's NeedTracker/NeedCatcher 1412 is illustrated. User A 1402 is a user posting a Need 1410 from the user client machine 224 through the web server 214 to the N-CAPE 202. The Automated System Controller 202e of the N-CAPE 202 then uses the Matching Engine 202b to match the Need 1410 to User B's NeedTracker/NeedCatcher 1412, which is located in User B's User Profile Database 206 and User File Repository 208. Notice of the matching need is sent to User B 1404 as an email. The email template is retrieved from the Template Repository 209, and directed to the mailer server 216 by the Automated System Controller 202d. The mailer server 216 then sends the email to User B's client machine 224. User B 1404 may react to the posted Need 1410 by either ignoring it, or providing Help or Pro-help 1406 depending on whether User B's company profile 1408 is basic or premium. If User B 1404 provides Help 1406, then the posted Help 1406 is sent from User B's machine 224 through the web server 214 to the N-CAPE 202. The Automated System Controller 202d of the N-CAPE 202 then directs the Help 1406 to the profile of User A 1402, and stores the Help 1406 in the User Profile Databases 206 and User File Repositories 208 of User A 1402 and User B 1404.

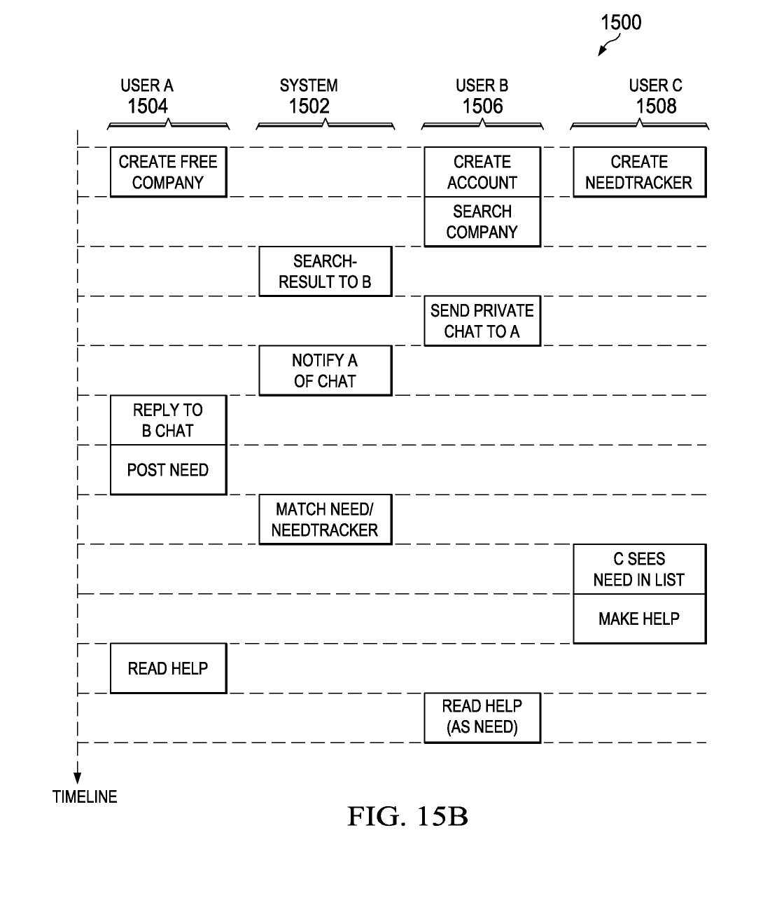

FIG. 15 is an exemplary process timeline 1500 illustrating the process flow of the disclosed system 1502 as User A 1504, User B 1506, and User C 1508 interact. FIG. 15A shows User A 1504 posting a Need, receiving Pro-help from User B 1506 and then interacting through private chat. Chatting may be initiated by a user through the web server 214. A user submits a chat request/message from the user's machine 224. The chat request/message is sent through the web server 214 to the Automated System Controller 202d of the N-CAPE 202. The Automated System Controller 202d then relays the message through the web server 214 to the machine 224 of the user receiving the chat request/message. The receiving user then sends their chat reply/message the same was as it was received. A copy of the chat dialogue is sent from the Automated System Controller 202d to the users' User Profile Databases 206, and the private sections of the users' User File Repositories 208. User C 1508 searches the system for the Need and accesses the information created by User A 1504 and User B 1506. When searching the system, search criteria is sent from the searching user's machine 224 to the Automated System Controller 202d. The Automated System Controller 202d searches the User Profile Database 206 and public (and private if the user has rights) sections of the User File Repository 208. Relevant search results are then stored in the searching user's profile in the User Profile Database 206. The search results are also sent from the Automated System Controller 202d through the web server 214 to the searching user's machine 224.

FIG. 15B shows User A 1504 creating a basic company profile and obtaining a Lead as User B 1506 accesses the company directory in the disclosed system to search for a Vendor. User A 1504 also posts a Need and receives Help from User C 1508, as User C's NeedTracker notified User C 1508 of User A's Need. Both User A 1504 and User B 1506 are able to read the Help posted by User C 1508.

### Need/NeedCatcher Matching

The automatically-generated relevance of a NeedCatcher to a given Need (or vice versa) is estimated by the Matching Engine 202b of the N-CAPE 202 using diverse sources of information from Syntactical, Semantical and User Behavioral Information categories. The following description of these sources provides background as to how relevance is estimated from the Subject, Description and Metadata of a Need with respect to a NeedCatcher. In this context, a Need and a NeedCatcher can be viewed as the same type of object composed of a Subject, a Description, and Metadata. Hereinafter this object, whether a Need or a NeedCatcher, will be referred to as a “document”. The term “user” will be used to denote a user with a Need or a user with a company profile indistinctly.

Syntactical Information Source (SYIS) includes information obtained by a syntactical analysis (performed by the Matching Engine 202b) of the Description and structure of a document. An example is the study of the frequency of a word's appearance in the Subject and Description of a document. Another example is the number of letters that match between two words from separate documents.

Semantical Information Source (SEIS) includes information obtained by a semantical analysis performed by the Matching Engine 202b. This is based on understanding the meaning and concepts expressed by the elements that compose a document. For example, in the phrase “Citroen white, 2 doors, year 2008,” a semantical analysis will recognize “Citroen” as a car brand, “2 doors” as the number of doors, “white” as a color and “year 2008” as a year. This kind of information is based on ontology, defined as a formal representation of concepts within a domain, and the relationships between those concepts. The construction of ontology is based on knowledge provided by a human, or concepts and relations estimated statically from documents or other objects. The appropriate mixture of both approaches improves the quality of the resulting ontology and reduces the cost of building it. The human intervention is provided by an administrative user from the administrator staff client machine 222. The administrative user accesses the Matching Engine 202b through the administration support server 212.

User Behavioral Information Source (UBIS) includes information obtained by the analysis of users'—including administrators'—behavior. For example, when a user provides a Help to a Need, it can be presumed (by the Automated System Controller 202d and Learning Engine 202a) that the estimated relevancy of the Need relative to the NeedCatcher was correct. When an administrator matches a Need and a NeedCatcher, the same assumptions can be made. On the other hand, if Help is never submitted, it may be implied that the match was not relevant. The implication that the match was not relevant is noted by the Learning Engine 202a, and either ignored, flagged for administrative intervention, or corrected by communicating the implication to the Matching Engine 202b and Rules Engine 202c. If the information is flagged for administrative intervention, then an email template is pulled from the Template Repository 209 by the Automated System Controller 202d, and then sent through the mailer server 216 or administration support server 212 to the administration staff client machines 222. An administrative user can then act upon the notification. Any change in information or data is then “learned” by the Learning Engine 202a and a copy of or reference to the data change may be stored in the Local Repository 202e. This kind of information is useful to estimate some parameters of the system according to what users find relevant, allowing the system to adapt and improve the quality of the service.

These sources of information are used to define and build the algorithms and data-structures involved in the automated NeedCatcher process as explained above. The elements of the NeedCatcher Adaptive Processing Engine 202 provide for automated improvement as well as administratively-controlled improvement.

### Relevance Matching

The relevance of a Need to a NeedTracker/NeedCatcher can be estimated by the Matching Engine 202b in one example by counting the number of matches between all terms present in two different documents. The terms involved in the matching process are different from the words and the metadata contained by the documents. A term is defined as an object obtained by applying processing to a given word, phrase, or metadata. The result of the processing of every word, phrase, or metadata generates one or more terms that improve the relevance estimation. The influence of every term is controlled by a weight related to each of those terms. This weight depends on some of the features of the related term; for example, the term's particular location in the structure of both documents and the context in which the documents are involved. Hence, some terms are more influential than others.

To obtain these weights it is important to distinguish among the three components of a document: Metadata, Subject and Description.

The Metadata component, by definition, is a set of data about the data. These have the purpose of providing context to facilitate the understanding of a document. This data is structured, which eliminates ambiguity. Some of these affect the relevance estimation. Examples include but are not limited to:
The rating of a user. For example, if a minimum rating is required by another user, it can be an excluding factor. Otherwise, it can be used to give less priority compared to a user with a higher rating.
The geographical area that a NeedCatcher covers. For example, if a Need has no preferences regarding from where and/or how far something should be delivered, the system will still give higher relevance to a local NeedCatcher (naturally providing coverage for a smaller area).
History of usage. For example, how quickly a user responsible for a NeedCatcher has been providing Help to relevant Needs. A user providing prompt Help will be given higher priority (assuming all else is equal), as rapid response is important for satisfying users posting Needs.

Other Metadata allows filtering according to settings defined by the user. For example:
The location where the Need may be satisfied or where the service may be provided.
The language of the document.
The amount of Help received versus the amount of Help expected.
Information about the user (or company that user represents) behind a NeedCatcher. For example, financial statements (the user could choose to exclusively receive Help from a company with a current financial statement) or local branch requirements (the user could choose to only receive Help from a company with a local physical presence).
One user has explicitly excluded any connection with another user.

Subject and Description consist of unstructured data, or so-called free-text. Algorithms are required to process this data, to extract meaning and structure from it, making it possible for machines to understand its content. This kind of data, although harder to process, gives more flexibility to the users when expressing their Needs or information about the services and products they provide.

The difference between the Subject and the Description is the influence that they have on the final relevance estimation. The Subject is shorter than the Description and thus considered to contain more important information about the document, which makes the terms extracted from the Subject more relevant than those extracted from the Description. The Description contains more extended information which describes the Need, Services or Product, depending on the case, and gives details that allow the user to obtain a better idea about what is needed or offered. Because this includes more information, some of the information is less essential and is intended to provide extra detail. Therefore, the terms extracted from the Description have less influence on the resulting relevance estimation than do the terms extracted from the Subject.

The process of extracting meaning and structure from the Subject and Description is described below. The process is the same for each, as they differ only in the influence they have on the final relevance estimation.

The method for estimating the contribution of a free-text component, from the two documents involved to the final relevance, is based on the extraction of terms. The Matching Engine 202b performs a weighted counting of the numbers of matches between the terms from one document with the terms from the other. The documents are originally stored in the user Profile Database 206, Database Cluster 204, and user File Repository 208. The Matching Engine 202b searches these locations for the relevant information.

The terms extraction is carried out by the Matching Engine 202b by:
1. Splitting the free-text by the longest contiguous series of blank characters, which allows the Matching Engine 202b to obtain the words (SYIS).
2. Normalizing the words into lower-case form. This allows the Matching Engine 202b to match words that were originally syntactically different, but have the same semantical meaning (SYIS).
3. Expanding the words into terms using a graph-denominated words expansion graph which consists of a weighted directed graph of nodes, which represents words or terms and a weighted directed link between them, representing some semantic relation. The weight of some of these links depends of the context of the word, which is defined by the co-apparition with other words in the document, and Metadata such as the related industry or other kinds of categories (SYIS, SEIS and UBIS).

The weight of each term is determined, as an example, by the combination of the following features. It should be appreciated that the above description are examples of weightings that have been found so far to be effective in determining relevance of terms, but that the weightings and importance of various types of terms can be adapted as the system is further developed. Any resulting claims in a patent stemming from the present application should not be implicitly limited by these terms in any way, but should instead be construed based on their own language.
Term frequency: The number of appearances of the term in the free-text field divided by the total numbers of terms. A term is more relevant if it is more frequent than other terms in the same free-text field (SYIS).
Term Subject-Description appearance: A term that is found in the Subject and Description of a document is more relevant to the document than one that only appears in one or the other (SYIS).
The inverse document frequency: The inverse of the number of documents in which the term appears. This means that rare terms are more relevant for a document than common ones (SYIS).
Descriptive words, such as big, yellow, light, etc. . . . are considered more or less relevant depending upon the context in which they are used (SEIS).
Terms which represent entities are more relevant. These include names of brands (Mac, Citröen, Dell) and geographic locations (Providencia, Santiago, USA, Calif.) among others (SEIS).
The document component relevance. The Subject is more relevant than the Description (SYIS).
The term's effectiveness weight: These weights are estimated by the correlation between the term and a successful match. A successful match occurs when a Need is sent to a user because the system considers it relevant to his NeedCatcher, and the match is confirmed when the user submits Help. When the term is present in both documents of a successful match, its relevance increases. When it is not, for example, if the system considers it relevant, but the users do not, the term's relevance decreases (UBIS).
Word's expansion weight. When a term is expanded via the words expansion graph, every characteristic of this term is weighted by the weight of the link between the original word and the expansion term (SYIS, SEIS, UBIS).

The words expansion graph is actually the union of several graphs including:
Levenstein distance graph. This graph contains every word that appears in the entire document collection, with the words put in lower case. A link is established if the Levenstein distance is not greater than a percentage of the number of letters of the shorter word involved in the distances computation. The Levenstein distance counts the number of changes needed to transform a word into the other, wherein a change is considered a character replacement, character deletion or character addition. The weight of the established link is the inverse of the obtained distance. This means that a word which needs fewer changes to become the other word is more related to it than others which need more changes (SYIS).
Stemming graph. A stemming algorithm is a process, which reduces words into their morphological root or stem. For example “rent,” “renting,” and “rented” have the same root “rent.” Generally it is sufficient that related words map to the same stem, which is not necessarily their morphological root. The stemming graph is an undirected graph, nodes of which represents words, and the links exist between two of them if they share the same stem (SYIS).
User behavior graph. This is not a graph by itself, it is the union of several graphs, such as those described above. The original links' weights are continuously adapted according to the users' behavior following the same strategy used to estimate “the term effectiveness weight.” The strategy increases the term's weight if it is involved in a successful match, otherwise the weight is decreased. This strategy allows the graph to preserve only the information that improves the service quality and to discard the information which makes it worse (UBIS).

The Matching Engine 202b lists the most relevant NeedCatcher from each user. Other NeedCatchers from the same user may be considered non-relevant, as the Matching Engine 202b matches no more than one instance of a Need to the same user during each Need cycle. From the list, the Matching Engine 202b matches the Need to the NeedCatchers with the highest relevancy. How many NeedCatchers the system relates to a Need is based on how many Helps are requested and on other information obtained from the system. Other information may include, but is not limited to, how fast similar Needs in that area have received Help, and the marginal value of an increased number of Helps for Needs with that Description.

By not matching a Need to all relevant NeedCatchers, the system fulfills two objectives: avoiding giving users with NeedCatchers the sensation of being spammed, and making sure Helps for the Buyers are more likely to be of high quality.

### Miscellaneous

Words with explicit content will be added to a list, which will be used to block information within Needs, Chat messages, and Offers in the system. Information containing words that may be abuse, depending upon their context, will pass through administrative support for manual inspection. All users have the ability to report someone or any content that they find offensive to the administrators. Users also have the ability to rate, comment, and respond to Needs, Help, and comments. By automatically analyzing a user's history in the disclosed system, the system can grant that user more or less permission based on its network (Friends) and description of Needs and Help.

The approach described in this disclosure is one example of the structure of this online service, but other approaches may be understood in the context of the presently described embodiments. For example, while the above description provides for “no categories,” “no restriction,” and “no exclusion,” it is possible to have a system that would still be generally free-form, without restriction, and in all languages that might still provide for the structured definition of one or more of these items.

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. An automated method implemented on an adaptive system, the method operable to provide an automated request for proposal process that adaptively matches a user's request for proposal to other users' profiles according to an adaptive algorithm that evaluates the closeness of the request for proposal to the certain users' profiles, the method comprising:
providing a first user account associated with a first user;
providing a plurality of other user accounts, each associated with one of a plurality of other users;
receiving a free-form request for proposal from the first user, the request for proposal including a free-form subject field and a free-form description field, wherein the free-form subject and description fields are not required to include certain words or categories;
developing, at least in part with input from respective ones of the plurality of other users, a plurality of other user profiles;
evaluating the closeness between the free-form request for proposal and at least some of the plurality of other user profiles; and
based on the closeness of the free-form request for proposal and the at least some of the plurality of other user profiles, making the free-form request for proposal available for review by certain of the plurality of other users.

2. The automated method as set forth in claim 1, wherein the request for proposal is a request for a commercial offer for goods or services.

3. The automated method as set forth in claim 1, wherein the request for proposal is a request for information.

4. The automated method as set forth in claim 1, wherein the certain of the plurality of users able to review the free-form request for proposal can each provide a proposal available for review by the first user, the proposal comprising at least one of free-form text, attached documents or files, and metadata.

5. The automated method of claim 4, wherein the metadata is operable to provide machine-readable data for automated comparison and distribution.

6. The automated method of claim 4, wherein the proposal comprises a public field and a private field, wherein data entered in the public field is reviewable by the first user and the plurality of other users, and data entered in the private field is reviewable by the first user and a selected portion of the plurality of other users.

7. The automated method of claim 6, wherein the selected portion of the plurality of other users is determined by the certain of the plurality of other users providing the proposal.

8. The automated method as set forth in claim 1, wherein at least some of the requests for a proposal and corresponding proposals are available for review by the plurality of other users.

9. The automated method as set forth in claim 1, wherein the request for proposal further comprises attached documents or files and metadata, the metadata operable to provide machine-readable data for automated comparison and distribution.

10. The automated method as set forth in claim 1, wherein the first user and the plurality of other users provide feedback to each other and to the adaptive system to enhance the adaptive system and adaptive algorithms.

11. The automated method as set forth in claim 1, wherein the first user account is a social user account, wherein the social user account is customizable and comprises a social user profile, the social user profile containing data pertaining to the first user.

12. The automated method of claim 11, and further comprising generating metadata at least in part from the social user account and social user profile, the metadata operable to provide structured context regarding the social user account and social user profile.

13. The automated method as set forth in claim 1, wherein the first user account is a commercial user account, wherein the commercial user account is customizable and comprises a commercial user profile, the commercial user profile containing data pertaining to the first user.

14. The automated method of claim 13, wherein the commercial user account is affiliated with a company, and comprises a company profile, the company profile containing data pertaining to the company affiliated with the first user.

15. The automated method of claim 14, and further comprising generating metadata at least in part from at least one of the commercial user account, commercial user profile, and company profile.

16. The automated method of claim 15, wherein the metadata is operable to provide structured context regarding at least one of the commercial user account, commercial user profile, and company profile.

17. The automated method as set forth in claim 1, wherein the plurality of other user accounts are social user accounts, wherein each social user account is customizable and comprises a social user profile, the social user profile containing data pertaining to its associated user.

18. The automated method of claim 17, and further comprising generating metadata at least in part from the social user account and social user profile, the metadata operable to provide structured context regarding the social user account and social user profile.

19. The automated method as set forth in claim 1, wherein the plurality of other user accounts are commercial user accounts, wherein each commercial user account is customizable and comprises a commercial user profile, the commercial user profile containing data pertaining to its associated user.

20. The automated method of claim 19, wherein the commercial user account is affiliated with a company, and comprises a company profile, the company profile containing data pertaining to the company affiliated with the associated user.

21. The automated method of claim 20, and further comprising generating metadata at least in part from at least one of the commercial user account, commercial user profile, and company profile.

22. The automated method of claim 21, wherein the metadata is operable to provide structured context regarding at least one of the commercial user account, commercial user profile, and company profile.

23. An automated method implemented on an adaptive system, the method operable to provide an automated request for proposal process that adaptively matches a user's request for proposal to other users' profiles according to an adaptive algorithm that evaluates the closeness of the request for proposal to the certain users' profiles, the method comprising:
providing a first user account associated with a first user;
providing a plurality of other user accounts, each associated with one of a plurality of other users;
receiving a free-form request for proposal from the first user, the request for proposal including a free-form subject field and a free-form description field, wherein the free-form subject and description fields are not required to include certain words or categories;
developing, at least in part with input from respective ones of the plurality of other users, a plurality of other user profiles;
evaluating the closeness between the free-form request for proposal and at least some of the plurality of other user profiles;
based on the closeness of the free-form request for proposal and the at least some of the plurality of other user profiles, making the free-form request for proposal available for review by certain of the plurality of other users;
receiving a proposal from at least some of the plurality of other users to whom the free-form request for proposal was made available for review, the proposal comprising at least one of free-form text, attached documents or files, and metadata; and
wherein the first user and the plurality of other users provide feedback to each other and to the adaptive system to enhance the adaptive system and adaptive algorithms.
